(19) United States
(12) Patent Application Publication
(10) Pub. No.: US 2022/0410745 A1
(43) Pub. Date: Dec. 29, 2022

(54) Robot for the automatic electric charging of an electric vehicle, charging group and automotive apparatus provided with said robot

(71) Applicant: DOMYGO S.R.L., SCANDIANO (RE) (IT)

(72) Inventor: Domenico CANTA, SCANDIANO (RE) (IT)

(21) Appl. No.: 17/772,401

(22) PCT Filed: Oct. 22, 2020
(86) PCT No.: PCT/IB2020/059916

§ 371 Date: Apr. 27, 2022

(30) Foreign Application Priority Data
Oct. 29, 2019 (IT) 102019000019982

(51) Int. Cl. B60L 53/35; B60L 53/16; B60L 53/31

(52) U.S. Cl. CPC B60L 53/35; B60L 53/16; B60L 53/31

(57) ABSTRACT

A robot (100) for the automatic electric charging of an electric vehicle (1) is described, comprising: a reference surface (110), a first rod (155) and a second rod (160), which are coplanar and parallel to each other, a support frame (200) with which the first rod (155) and the second rod (160) are slidingly associated respectively along a first sliding axis (K1), perpendicular to a longitudinal axis (L1) of the first rod (155), and a second sliding axis (K2), perpendicular to a longitudinal axis (L2) of the second rod (160), and wherein said rods (155, 160) are movable along said sliding axes between a first position, in which the mutual distance between the rods is minimal, and a second position, in which the mutual distance between the rods is maximal, a resilient element (265) configured to exert a force on said rods (155,160) such that in order to bring the rods (155, 160) from the first position to the second position, it is necessary to overcome said force of the resilient element, a supporting frame (150) with which the support frame (200) is slidingly associated with respect to a sliding axis (X) perpendicular to the longitudinal axes (L1, L2) of the rods (155, 160), a lifting group (145) configured to move the supporting frame (150) along a vertical direction, between a first position, in which the distance of the rods (155, 160) from the reference surface (110) is minimal, and a second position, in which the rods (155, 160) are located at a higher level than the reference surface (110) and the distance from the reference surface (110) is maximal, and a power supply socket (105) adapted to be connected by means of a cable to an electric power source, said power supply socket (105) being coupled to the first rod (155).

### TECHNICAL FIELD

The present invention relates to a robot for the automatic electric charging of an electric vehicle, a charging group comprising such a robot and an automotive apparatus provided with such a robot. In particular, the invention relates to a robot for automatically charging a car configured to automatically connect a power supply socket to a corresponding charging plug of a vehicle to which the vehicle battery is connected. In detail, the charging plug of the vehicle is not the charging plug

### PRIOR ART

Robots for the automatic electric charging of an electric vehicle are known, which are configured to automatically insert a supply plug into a charging plug of the vehicle so as to charge the battery of the electric vehicle.

For example, there are robots configured to connect to a charging plug of the vehicle accessible from a door made in the vehicle bodywork. These robots are generally anthro-pomorphic robots, which are particularly expensive, complicated to programme and not particularly suitable to be installed in outdoor public places. Furthermore, for operation they need video cameras or other optical sensors to identify the vehicle and its position of the charging plug, thus making the robot particularly complicated, expensive and not very suitable to operate efficiently and regularly when installed in outdoor public places. Another category comprises the robots configured to identify and connect to a charging plug fixed to the lower body of the vehicle. A known configuration of this type of robot envisages a self-guided mobile platform which, based on special sensors, searches for and connects to a charging plug fixed to a lower portion of the vehicle frame, for example to an underbody bulkhead of the vehicle. A problem with this known solution lies in the intrinsic complications of software design and the need for sophisticated and expensive sensors. The object of the present invention is to make available a more robust robot for charging electric vehicles, in particular weather-resistant and that can be installed in outdoor public spaces, which does not require long periods of software programming in order to guarantee their correct operation, in the context of a simple and rational constructive solution.

Such object is achieved by the features of the invention indicated in the independent claim. The dependent claims outline preferred and/or particularly advantageous aspects of the invention.

### DISCLOSURE OF THE INVENTION

The invention, in particular, makes available a robot for the automatic electric charging of an electric vehicle comprising:
a reference surface,
a first rod and a second rod, which are coplanar and parallel to each other,
a support frame with which the first rod and the second rod are slidingly associated respectively along a first sliding axis, perpendicular to a longitudinal axis of the first rod, and a second sliding axis, perpendicular to a longitudinal axis of the second rod, and wherein said rods are movable along said sliding axes between a first position, in which the mutual distance between the rods is minimal, and a second position, in which the mutual distance between the rods is maximal,
a resilient element configured to exert a force on said rods such that in order to bring the rods from the first position to the second position it is necessary to overcome said force of the resilient element,
a supporting frame with which the support frame is slidingly associated with respect to a sliding axis parallel to the longitudinal axes of the rods,
a lifting group configured to move the supporting frame along a vertical direction, between a first position, in which the distance of the rods from the reference surface is minimal, and a second position, in which the rods are located at a higher level than the reference surface and the distance from the reference surface is maximal, and
a power supply socket adapted to be connected by means of a cable to an electric power source, said power supply socket being coupled to the first rod.

Thanks to this solution, a robot is made available for automatically charging a particularly robust electric vehicle, in particular weather-resistant and that can be installed in outdoor public places, provided with a limited number of actuators, of such simple actuation, so that it does not require long periods of software programming in order to guarantee its correct operation. Moreover, the robot is particularly versatile and usable since it automatically adapts to vehicles provided with differently sized wheels and is able to automatically compensate, without the need for sensors adapted to detect the orientation of the vehicle, an imperfect positioning of the vehicle on the reference surface.

Another aspect of the invention may contribute to improving this adaptability advantage without the need for sensors adapted to detect the orientation of the vehicle, according with which the support frame can be rotatably associated with the supporting frame with respect to a vertical rotation axis.

This feature makes it possible to compensate for situations in which the rotation axis of the wheel, when it is positioned on the reference surface, is not parallel to the longitudinal axes of the rods.

According to another aspect of the invention, the robot can comprise a first roller rotatably associated with the first rod with respect to the longitudinal axis of the first rod itself and a second roller rotatably associated with the second rod with respect to the longitudinal axis of the second rod itself.

In this way it is possible to reduce the friction of the rods with the tread of the tire when they run on it, thus the dimensions of the motors necessary to actuate the lifting group are reduced, and by avoiding movement uncertainties due to friction it is furthermore possible to use encoders and open loop controls to perform a check of the vertical position of the rods, all for the benefit of the programming time.

According to another aspect of the invention, the power supply socket can be of the type comprised in the group among type 1, type 2, ccs2 and chademo.

In this way, that is since they are standard plugs, it is easier to maintain the robot than ad hoc made plugs, since in the event of a failure it is easier to find a spare part.

An aspect of the invention envisages that the robot can comprise a base provided with the reference surface, a first hump and a second hump placed side by side with the reference surface along a direction transverse to the longitudinal axes of the first rod and the second rod and projecting vertically from the reference surface, wherein the first hump comprises a groove adapted to accommodate the first rod and the second hump comprises a groove adapted to accommodate the second rod.

Thanks to this solution the robot makes available some references that can help the vehicle operator in positioning the same vehicle on the reference surface and furthermore, by allowing the rods to be positioned in the humps, the rods may not interfere with the maneuvers of the vehicle without the need to create grooves in the ground on which the robot rests.

A further aspect of the invention envisages that the robot can comprise a protective casing inside which the support frame, the resilient element and the lifting group are completely contained and which comprises a first slot crossed by the first rod and a second slot crossed by the second rod, in such a way that said rods protrude outwardly from the casing.

In this way the robot mechanisms are effectively protected against atmospheric agents and tampering attempts. For example, this result cannot be achieved by using an anthropomorphic robot or a self-propelled platform that moves on the ground supporting the vehicle.

The invention also makes available a charging group comprising:
a charging plug adapted to be electrically connected by means of an electric cable to a battery of an electric vehicle provided with wheels resting on the ground,
a robot, according to any one of the features presented above, which inserts the power supply socket into the power charging plug so as to form an electrical connection,
   wherein the charging plug is adapted to be rigidly connected to a first portion of a hub of the vehicle, which hub comprises the first portion and a second portion rotatably associated with the first portion and to which a vehicle wheel is integral in rotation.

Thanks to this solution, the charging plug is located at an external point of the vehicle which is easily accessible, but at the same time it is protected from impacts, which allows extending the useful life of the charging plug itself. Moreover, in this way it is sufficient to exploit the orientation of the wheel to which the power charging plug is connected to orient the power supply socket in accordance with the power charging plug

According to an aspect of the invention, the power supply socket of the robot can be connected to the first rod by means of a resilienta resilient element configured to push the plug along a direction transverse to the longitudinal axis of the first rod itself, and wherein the charging group comprises a lead-in surface which is convergent towards the power charging plug, is adapted to be rigidly connected to the first portion of the hub, and is configured to be contacted by the power supply socket under the thrust of said resilient element to guide at least in part the power supply socket towards the power charging plug.

In this way the robot does not need any sensor and/or motorised drive to move the power supply socket with respect to the first rod. Therefore, since the number of components of the robot is smaller than a solution requiring sensors, the likelihood that one of them will break is smaller.

The invention also makes available an automotive apparatus comprising an electric vehicle, which is provided with a plurality of wheels resting on the ground and an electric battery configured to supply an electric motor of the vehicle adapted to put at least one of said wheels in rotation, said automotive apparatus also comprising a charging group provided with:
a power charging plug connected by means of an electric cable to the battery of the vehicle and rigidly connected to a first portion of a hub of the vehicle, which hub is provided with the first portion and a second portion directly integral in rotation with a wheel of the vehicle and rotatably associated with the first portion
a robot, according to any one of the features presented above, which inserts the power supply socket into the power charging plug so as to form an electrical connection.

According to another aspect of the invention, the power supply socket of the robot can be connected to the first rod by means of a resilient element configured to push the plug along a direction transverse to the longitudinal axis of the first rod itself and in which at least one of the vehicle and the charging group comprises a lead-in surface, which is rigidly connected to the first portion of the hub and is convergent towards the power charging plug.

### BRIEF DESCRIPTION OF THE DRAWINGS

Further features and advantages of the invention will be more apparent after reading the following description provided by way of a non-limiting example, with the aid of the figures shown in the accompanying drawings.

FIG. 1 is a front axonometric view of a robot according to the invention.

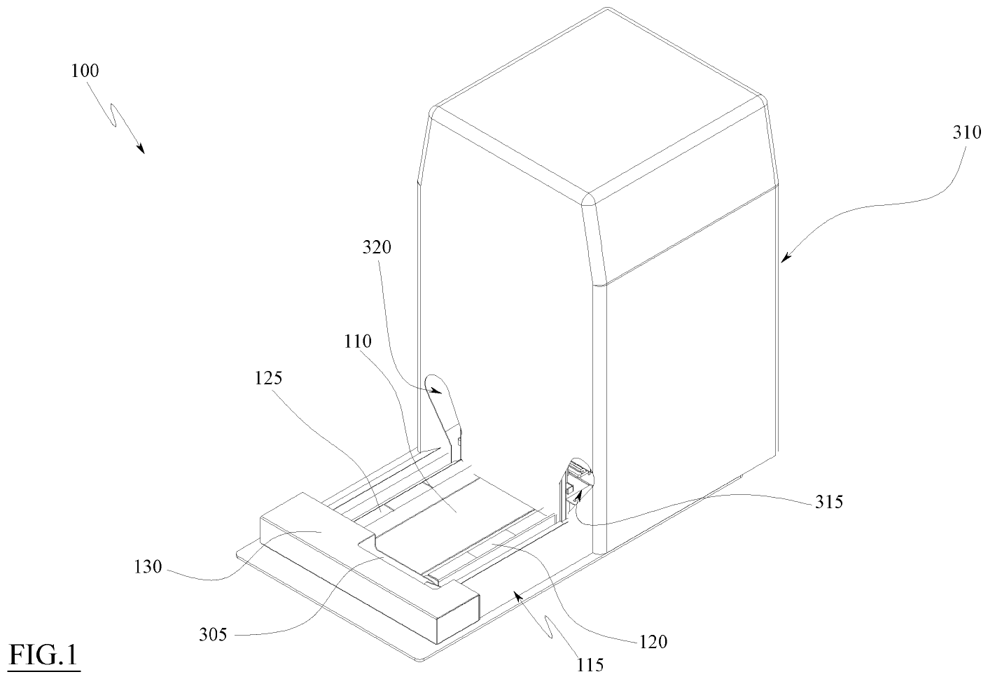

FIG. 2 is an axonometric view of the robot of FIG. 1 in which a protective casing of the robot itself has been removed.

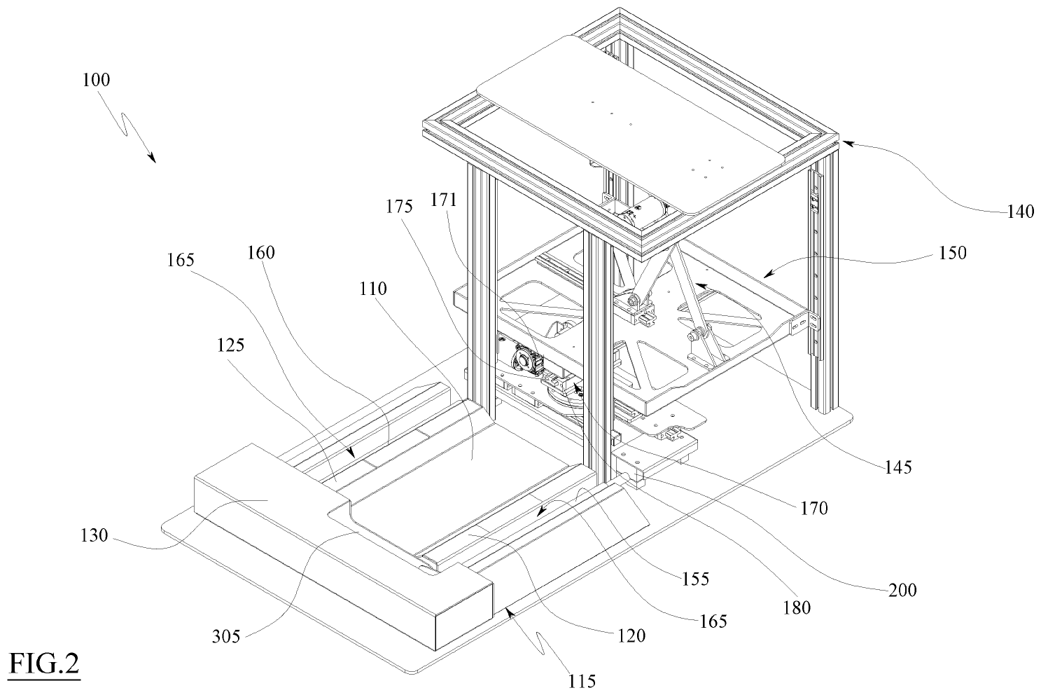

FIG. 3 is a side view of the robot of FIG. 2.

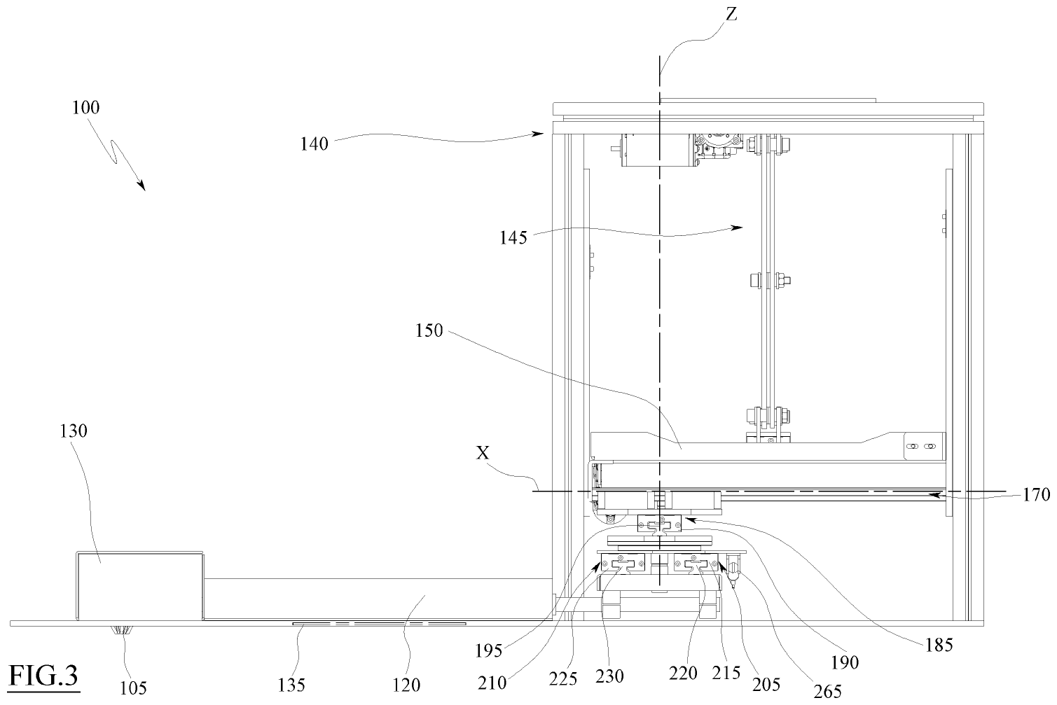

FIG. 4 is a schematic partial section view of an automotive apparatus according to the invention provided with a vehicle and a charging group comprising the robot of the preceding figures.

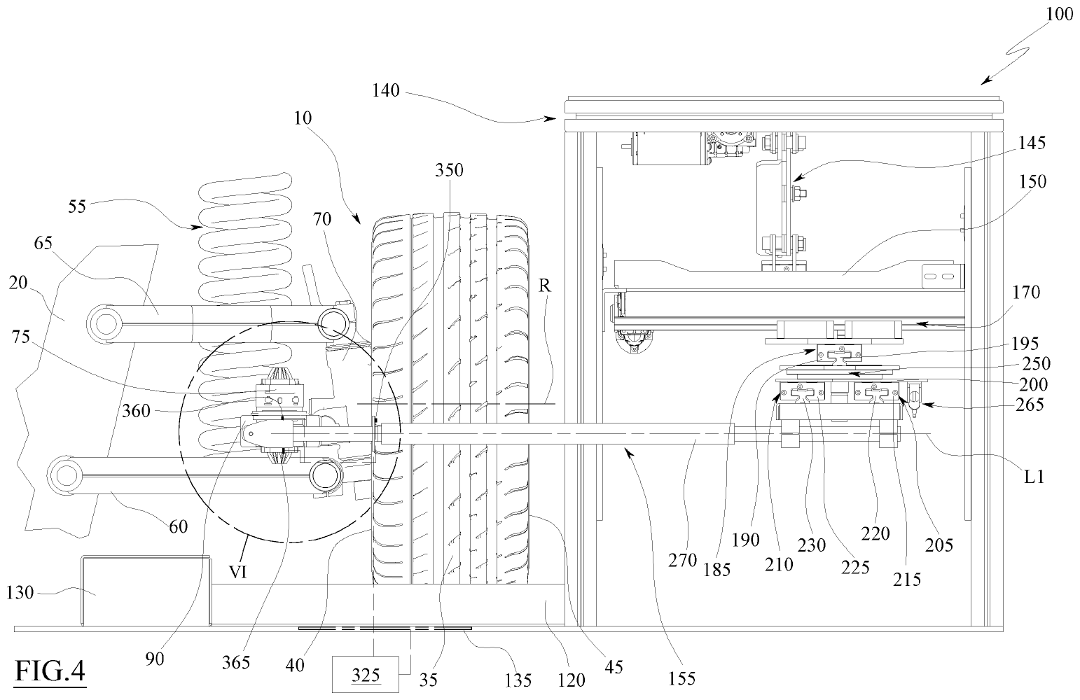

FIG. 5 is a view from above of FIG. 4.

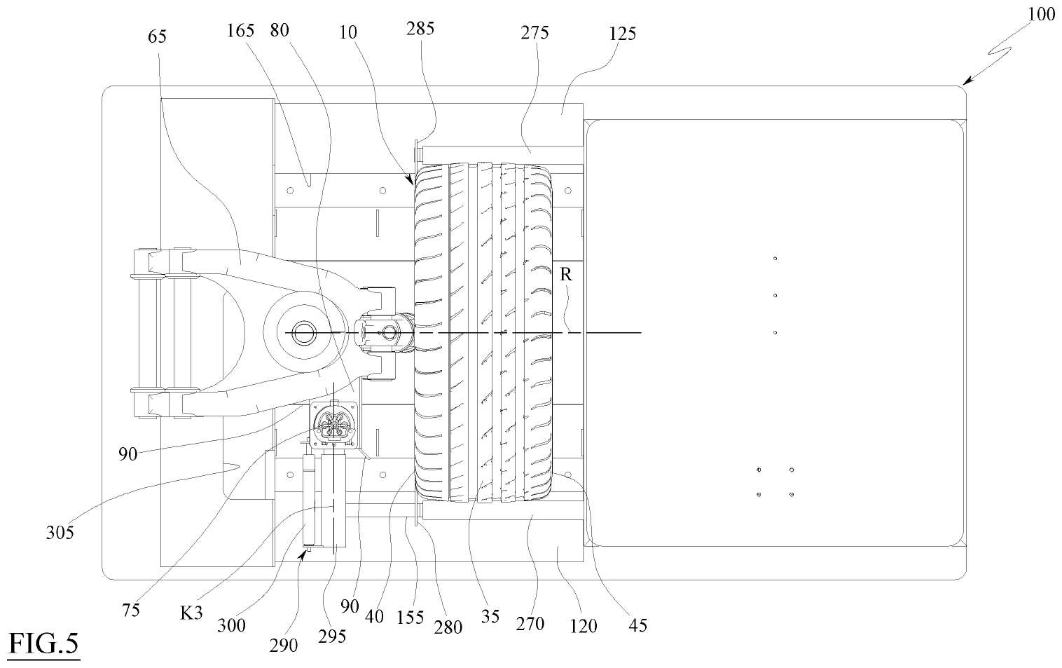

FIG. 6 is an enlargement of detail VI of FIG. 4.

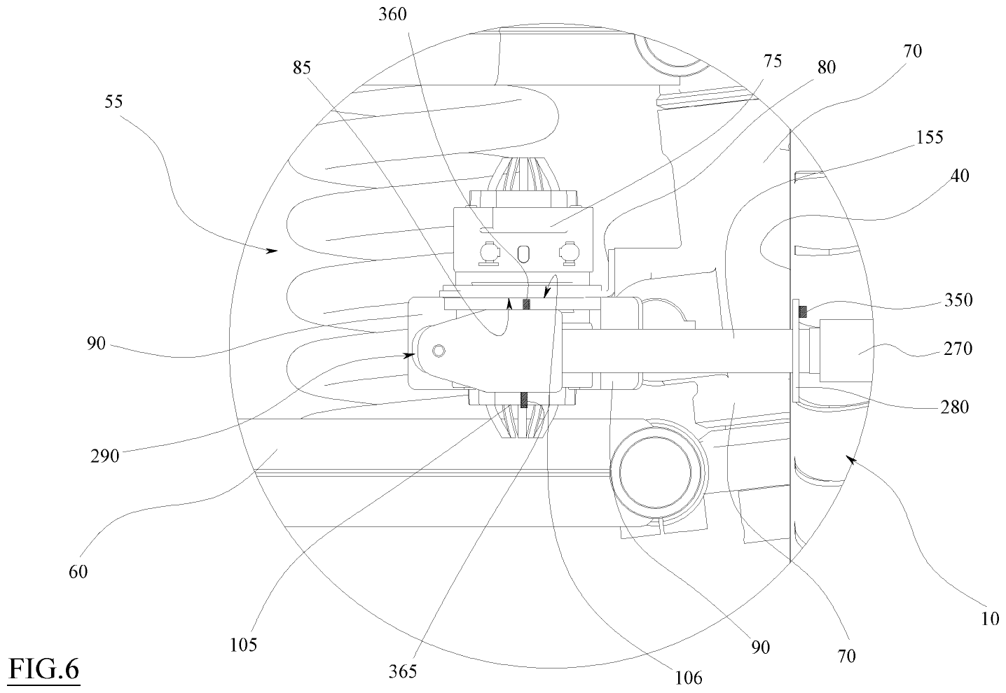

FIG. 7 is a partial schematic view of the automotive apparatus according to the invention.

FIG. 8 is an axonometric view of a portion of the robot according to the preceding figures.

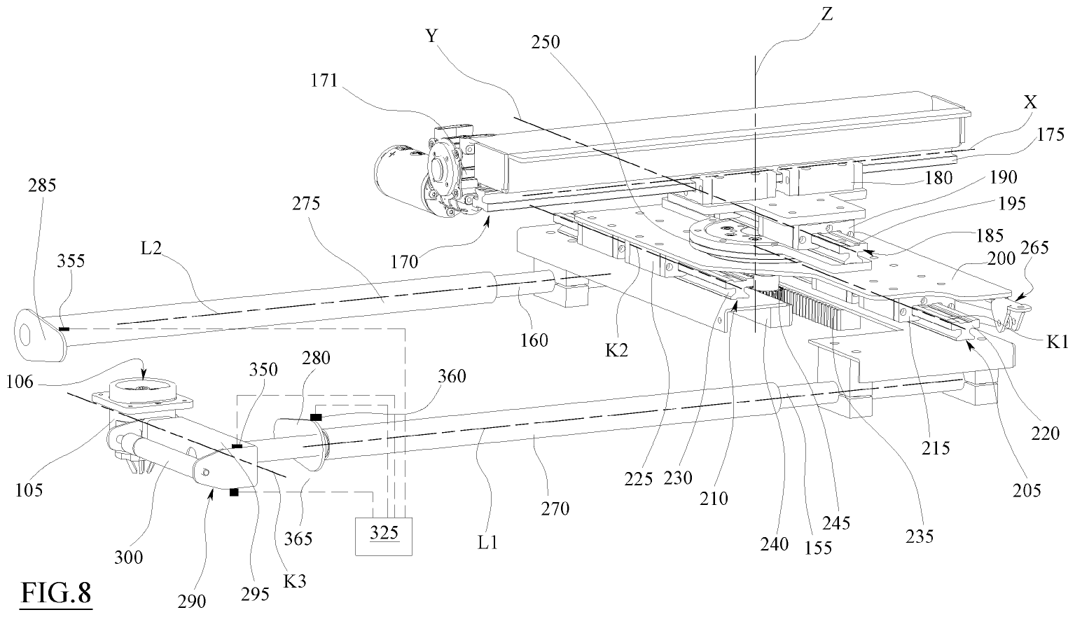

FIG. 9 is a side view of the vehicle of FIG. 4.

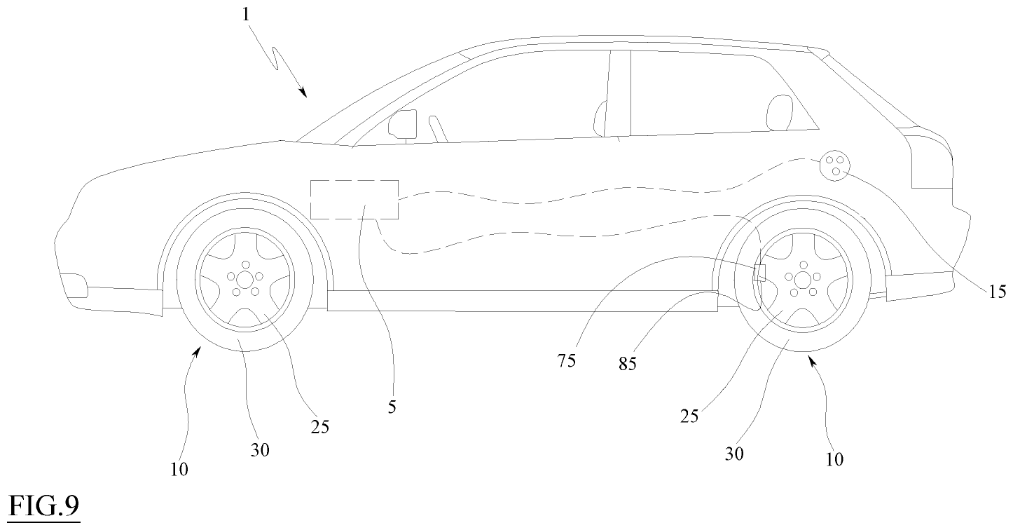

### DETAILED DESCRIPTION

With particular reference to the aforementioned figures, an automotive apparatus is described which is provided with an electric vehicle 1, such as for example an electric vehicle used for transporting people and/or goods, in particular for electrically charging an electric car.

The electric vehicle 1 comprises a battery 5 configured to supply at least one motor (not shown) adapted to put in rotation at least one wheel 10 of a plurality of wheels 10 resting on the ground in order to run the vehicle itself.

The electric vehicle can comprise a main power charging plug 15, that is a power charging plug of original equipment, connected by means of a cable to the battery 5 and to which a power charging plug can be connected so as to form an electrical connection adapted to enable charging the battery. For example, the main power charging plug 15 is accessible from the outside of the vehicle by removing a cover made in a vehicle bodywork itself.

The vehicle 1 comprises a frame 20, for example defining a passenger compartment (not shown), with which the wheels resting on the ground are rotatably associated with respect to corresponding rotation axes.

In particular, each wheel 10 comprises a rim 25 and a tire 30 mounted on this rim 25. The tire 30 has a tread 35 that is concentric with the rim, an inner shoulder 40 facing the frame 20 of the vehicle 1 and an outer shoulder 45 facing outwards. These shoulders connect the tread 35 to the rim 25 on which the tire is installed.

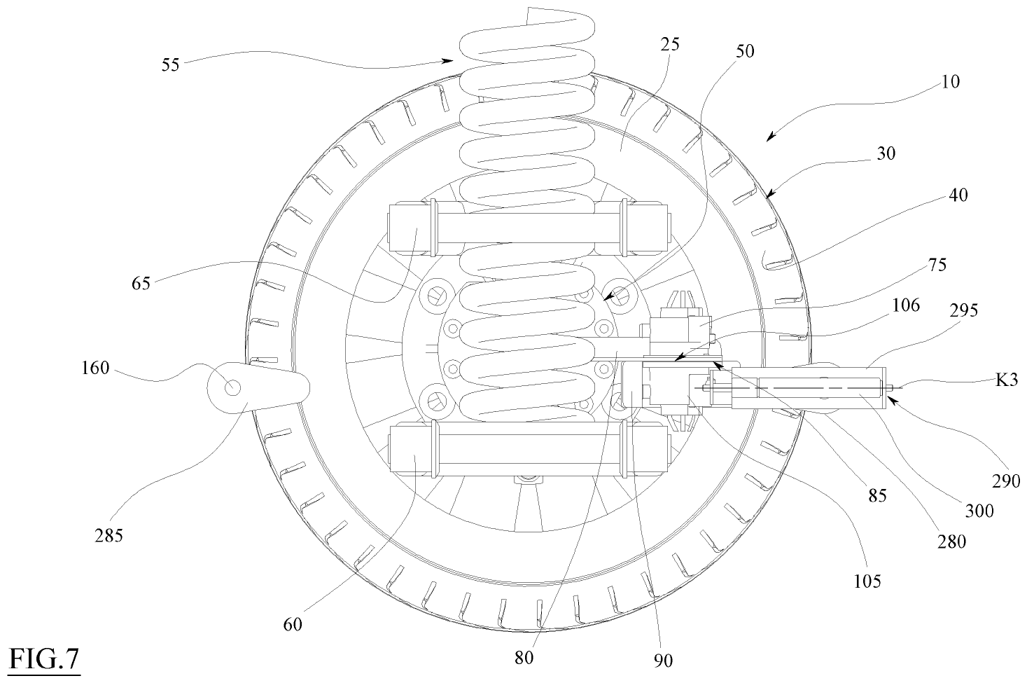

The vehicle 1 comprises a hub 50 (see FIG. 7) for each wheel 10 of the plurality of wheels 10, which hub 50 is provided with a first portion and a second portion rotatably associated with the first portion defining a respective rotation axis R of the wheel 10 with respect to the frame 20 and in which a respective wheel 10 of the vehicle 1 is rigidly integral in rotation to said second portion, that is with which the rim 25 of a respective wheel 10 is rigidly integral in rotation.

Furthermore, each hub 50 is preferably connected to the frame 20 of the vehicle 1 by means of a suspension, which for example comprises an articulated mechanism, provided with at least a first portion hinged to the frame and a second portion to which the first portion of the hub 50 is rigidly fixed without residual degrees of freedom, and a shock absorber 55 connected to the articulated mechanism.

In the embodiment shown in the figures, the articulated mechanism comprises a first element 60 which at one of its first end is hinged to the frame 20, for example with respect to a horizontal axis, a second element 65 which at one of its first end is hinged, for example with respect to a horizontal axis, to the frame 20 at a point of the frame that is distinct and eccentric with respect to the point in which the first element is hinged, and a third element 70, which is hinged to a pair of its ends that are opposite to the first element 60 and to the second element 65 at respective second ends opposite to the first ends. The first portion of the hub 50 is rigidly fixed, for example without residual degrees of freedom, to the third element and the shock absorber 55, which, for example comprising a helical compression spring, exerts a force along a longitudinal axis of the shock absorber itself and one of the first element 60 and the second element 65 is hinged to a longitudinal end thereof of the shock absorber, preferably to the first element 60 which is located at a lower level than the second element 65.

The automotive apparatus also comprises an electric charging group of the battery 5 of the vehicle 1 provided with a power charging plug 75 connected by means of an electric cable to the battery 5 of the vehicle 1. In particular, the power charging plug 75 is connected to the battery in parallel with respect to the main power charging plug 15, substantially constituting an auxiliary power charging plug for the vehicle 1.

The power charging plug 75 is of the type comprised among the following group of charging plugs type 1, type 2, ccs2 and chademo. Preferably the power charging plug 75 is also of the male type.

In the shown embodiment, the power charging plug 75 is integral with the first portion of the hub of a rear wheel of the plurality of wheels, however in an embodiment not shown the power charging plug is integral with the first portion of the hub of a front wheel of the plurality of wheels 10.

The power charging plug 75 is rigidly connected, for example by means of a rigid connection body 80, that is not deformable under normal workloads, to the first portion of a hub of the plurality of wheels 10. In particular, the connection body 80 is rigidly fixed, for example directly, preferably also without residual degrees of freedom, to the third element 70 of the suspension and the power charging plug 75 is fixed (directly) without residual degrees of freedom to the connection body.

The power charging plug 75 is preferably facing downwards, that is the power charging plug 75 has an interface face 85, through which a complementary power supply socket engages to form an electrical connection, which interface face is facing downwards (when the vehicle 1 is under normal conditions of use). For further detail, this interface face is substantially perpendicular to a vertical axis.

Said connection body 80 can be shaped in such a way that the power charging plug 75, that is the interface face thereof, is at a predetermined vertical distance from the abutment surface, for example comprised between 15 cm and 40 cm.

Moreover, the connection body 80 can be shaped in such a way that the power charging plug 75 is positioned at a first predetermined horizontal distance from a vertical plane on which the rotation axis R of the wheel 10 lies in the proximity of which the power charging plug itself is located, this second predetermined horizontal distance being comprised between 5 cm and 25 cm.

Furthermore, the connection body 80 can be shaped in such a way that the power charging plug 75 is positioned at a second predetermined horizontal distance from a vertical plane tangent to the inner shoulder 40 of the tire proximal to the power charging plug itself, for example this second predetermined horizontal distance being comprised between 20 cm and 40 cm.

Each of these three predetermined horizontal distances is measured from a central point of the interface face.

It is not excluded that in an alternative embodiment not shown, the main charging plug can be positioned like the auxiliary power charging plug described above and in this case the charging group does not comprise the auxiliary power charging plug.

The charging group can also comprise a lead-in surface 90 that is convergent towards the power charging plug 75, that is convergent towards the interface face 85, for example made in the connection body 80 and therefore rigidly connected without residual degrees of freedom to the first portion of the hub 50, preferably facing in a direction opposite to the wheel proximal to the power charging plug 75.

The lead-in surface extends below the power charging plug 75, that is the interface face 85 of the power charging plug, for example along a vertical stretch comprised between 5 cm and 20 cm.

For example, the lead-in surface comprises a first portion and a second portion at a right angle to one another, of which the first portion lies on a vertical plane parallel to the rotation axis R of the wheel 10 and the second portion lies on a vertical plane perpendicular to the rotation axis R.

The lead-in surface 90 can also comprise a third portion, which lies on a vertical plane and branches off from the first portion in a direction approaching the rotation axis R of the proximal wheel 10, and a fourth portion, which lies on a vertical plane and branches off from the second portion in a direction approaching the inner shoulder 40 of the tire 30 of the proximal wheel 10.

The charging group then comprises a robot 100, provided with a power supply socket 105 connected by means of an electric cable to an electric power source, which robot 100 is configured to insert the power supply socket 105 into the power charging plug 75 so as to form an electrical connection between the electric power source and the battery 5 of the vehicle 1. The electric power source can for example comprise a connection to the domestic or industrial electrical energy distribution network and/or an electric battery. The power supply socket 105 is of the same type as the power charging plug 75 and mated thereto. Therefore in the illustrated embodiment the plug 75 forms an electrical connection with the socket 105, however equivalently, the electric charging group of the battery 5 of the vehicle 1 could comprise an electric charging socket and the robot 100 could comprise an electric power supply socket which forms an electrical connection to the plug of the battery charging group.

In the shown embodiment, the robot 100 comprises a reference surface 110, for example flat and lying on a horizontal plane, preferably raised with respect to the ground supporting the robot.

The robot 100 can comprise a base 115 which is provided with the resting surface. This base can comprise a first hump 120 and a second hump 125 having an elongated shape along respective longitudinal axes parallel to each other and between which the reference surface is interposed. In particular, said humps are in direct contact with a pair of opposite sides of the same reference surface. Furthermore, each hump has a trapezoidal cross-section with a smaller base facing upwards.

The base 115 may further comprise a bead 130, transverse to the longitudinal axes of the first hump 120 and of the second hump 125, placed side by side with a single side to the reference surface 110 and which substantially connects the first hump 120 to the second hump 125.

The robot 100 can comprise a presence sensor 135 with which it is possible to detect the presence of a wheel of the vehicle 1 on the reference surface 110. For example, this sensor can comprise a weight sensor, preferably installed inside the base 115, below the reference surface 110. It is not excluded that in alternative embodiments the presence sensor may alternatively or additionally comprise an optical type sensor.

The robot 100 can comprise a bearing frame 140, provided with at least one foot resting on the ground, and a lifting group 145 connected to the bearing frame 140 and configured to move a supporting frame 150 along a vertical axis between a first position, in which the level of the supporting frame 150 is minimal and a second position, in which the level of the supporting frame 150 is maximal.

For example, the lifting group 145 comprises a pantograph-articulated mechanism, preferably fixed to a top portion of the bearing frame 140 and to the supporting frame 150 on one side of the same supporting frame facing upwards, and configured in such a way that the supporting frame is always at a lower level than the top portion of the supporting frame. In practice, the supporting frame 150 appears to be substantially hung to the bearing frame by means of the pantograph-articulated mechanism.

The supporting frame is associated by means of vertical guides to the bearing frame and is for example shaped like a plate-like body.

The robot 100 comprises a first rod 155 to which the power supply socket 105 and a second rod 160 are connected, which are substantially coplanar to each other, are provided with longitudinal axes, L1 and L2 respectively, parallel to each other and are connected to the supporting frame 150 in such a way that when the supporting frame 150 is in the first position, the first rod 155 and the second rod 160 are at the minimal distance from the reference surface, and when it is in the second position, the first rod 155 and the second rod 160 are at a higher level than the reference surface 110 and the distance from the reference surface is maximal.

In particular, in the shown embodiment, the first hump 120 and the second hump 125 each comprise a respective groove 165 that is open upwards and adapted to accommodate a respective rod 155, 160. In this case, in the first position, the first rod and the second rod are at a higher level than the reference surface 110 and at least such that said rods do not project above the respective grooves 165.

The first rod 155 and the second rod 160 project in a cantilever fashion from the supporting frame, for example also from the support frame, in a direction moving away therefrom horizontally. In particular, the rods 155, 160 have a longitudinal extension such that any imaginary plane perpendicular to the longitudinal axes of the rods and which intersects the reference surface, also intersects the rods.

The robot 100 can comprise a first linear guide 170, interposed between the rods 155, 160 and the supporting frame 150, defining a sliding axis X parallel to the longitudinal axes of said rods, for example said sliding axis X also lying on a plane parallel to a plane on which the longitudinal axes of the rods lie.

In particular, the first linear guide 170 comprises a first portion 175 fixed, for example without residual constraints of freedom and preferably also directly, to the supporting frame 150, and a second portion 180 movable with respect to the first portion 175 along the sliding axis X.

The robot also comprises a drive 171 configured to move the first rod 155 and the second rod 160 along the sliding axis X by means of the first linear guide 170, that is configured to move the second portion 180 of the first linear guide 170 with respect to the first portion 175.

The robot 100 can then comprise a second linear guide 185, also definable as a linear compensation guide, interposed between the rods 155, 160 and the first linear guide 170 and defining a sliding axis Y perpendicular to the longitudinal axes of said rods, for example also lying on a plane parallel to a plane on which the longitudinal axes of the rods lie.

In particular, the second linear guide 185 comprises a first portion 190 fixed, for example without residual constraints of freedom and preferably also directly, to the first linear guide 170, that is to the second portion 180 of the first linear guide 170, and a second portion 195 movable with respect to the first portion 190 along the sliding axis Y.

The second portion 195 of the second linear guide 185 is idly coupled to the first portion 190 of the second linear guide 185.

The robot 100 can comprise a support frame 200 with which the first rod 155 and the second rod 160 are slidingly associated respectively along a first sliding axis K1, perpendicular to a longitudinal axis of the first rod, and a second sliding axis K2, perpendicular to a longitudinal axis of the second rod. In particular, the first rod 155 and the second rod 160 are movable with respect to the support frame only with respect to the first sliding axis K1 and to the second sliding axis K2.

The sliding axes K1 and K2 are coplanar and parallel to each other.

In the shown embodiment, the robot comprises a third linear guide 205 and a fourth linear guide 210 defining the first sliding axis K1 and the second sliding axis K2 respectively. The third linear guide 205 comprises a first portion 215 fixed, for example without residual constraints of freedom and preferably also directly, to the support frame 200 and a second portion 220 movable with respect to the first portion 215 along the first sliding axis K1 and fixed, for example without residual constraints of freedom and preferably also directly, to the first rod 155.

The second portion 220 of the third linear guide 205 is idly coupled to the first portion 215 of the third linear guide itself.

The fourth linear guide 210 comprises a first portion 225 fixed, for example without residual constraints of freedom and preferably also directly, to the support frame 200 and to a second portion 230, movable with respect to the first portion 225 along the second sliding axis K2 and fixed, for example without residual constraints of freedom and preferably also directly, to the second rod 160.

The second portion 230 of the fourth linear guide 210 is idly coupled to the first portion 225 of the fourth linear guide 210.

The rods 155, 160 are movable along said sliding axes K1, K2 between a first position in which the mutual distance between the same rods is minimal and a second position, in which the mutual distance between the rods is maximal. In particular in the first position, the distance is preferably comprised between 25 cm and 45 cm.

Moreover the rods are positioned with respect to the reference surface in such a way that, both in the first position and in the second position, a central portion of the reference surface is interposed between the projections of the rods 155, 160 on a lying plane of the same reference surface.

In particular, this central portion of the reference surface is located at a vertical plane and parallel to the longitudinal axes of the rods 155, 160 when said rods are in the first position defined by the lifting group 145.

The robot can comprise a mechanism configured in such a way that the movement of the rods 155, 160 between the first position and the second position is simultaneous for both rods and the distance of the first rod 155 from a vertical median plane interposed between said rods is always the same as the distance of the second rod 160 from said plane. In the shown embodiment, this mechanism comprises a first rack 235 integral in sliding with the second portion of the third guide, a second rack 240 integral in sliding with the second portion 230 of the fourth linear guide, and a pinion 245 directly interposed between the two racks and which simultaneously meshes with both. Preferably, said pinion is rotatably associated in an idle manner with the supporting frame 150 with respect to a vertical rotation axis.

The support frame 200 can be rotatably associated, for example in an idle manner, with the supporting frame 150 with respect to a vertical rotation axis Z. In particular, the support frame 200 is directly connected and rotatably associated with the second linear guide 185, that is with the second portion of the second linear guide 185, with respect to the vertical axis Z. For example, the support frame 200 is movable with respect to the second linear guide 185, that is to the second portion of the second linear guide, only rotatably with respect to the axis of vertical rotation Z.

In particular, the robot can comprise a bearing 250 provided with a first portion fixed, for example without residual constraints of freedom and preferably also directly, to the supporting frame 150 and a second rotatable portion to the first portion with respect to the vertical rotation axis Z and fixed, for example without residual constraints of freedom and preferably also directly, to the support frame 200.

The second portion of the bearing 250 is idly coupled to the first portion of the bearing. The robot 100 can comprise a resilient element 265 configured to exert a force on said rods such that in order to bring the rods 155, 160 from the first position to the second position it is necessary to overcome said force of the resilient element. For example, this elastic element 265 comprises a gas spring provided with an end directly connected to the support frame 200 and an opposite end directly connected to the second portion of one of the third linear guide and the fourth linear guide.

The robot 100 can comprise a first roller 270 rotatably associated, for example in an idle manner, with the first rod 155 with respect to the longitudinal axis of the first rod itself and a second roller 275 rotatably associated, for example in an idle manner, with the second rod 160 with respect to the longitudinal axis of the second rod itself.

The robot 100 can comprise a first abutment body 280 integral in sliding with the first rod 155 with respect to the first sliding axis K1 and positioned in a portion of said first proximal rod at a longitudinal end of the first rod itself that is distal from the first sliding axis K1. The first abutment body 280 projects radially towards the second rod 160 and comprises a surface perpendicular to the longitudinal axis of the first rod 155 and facing the lifting group 145.

A distance of this perpendicular surface from the power supply socket 105, measured along a direction parallel to the longitudinal axis of the first rod 155, is equal to the second predetermined horizontal distance.

The robot 100 can comprise a second abutment body 285 integral in sliding with the second rod 160 with respect to the second sliding axis K2 and positioned in a portion of said second proximal rod at a longitudinal end of the second rod itself that is distal from the second sliding axis K2.

The second abutment body 285 projects radially towards the first rod 155 and comprises a surface perpendicular to the longitudinal axis of the second rod 160 and facing the lifting group 145.

A distance of this perpendicular surface from the second sliding axis K2, measured along a direction parallel to the longitudinal axis of the first rod 155, is equal to the distance between the perpendicular surface of the first abutment body 280 and the first sliding axis K1.

The power supply socket 105 comprises an interface face 106, through which the engagement with the complementary power charging plug 75 takes place to form the electrical connection, and the power supply socket 105 is associated with the first rod in such a way that the interface face is facing upwards. For further detail, this interface face 106 is substantially perpendicular to a vertical axis.

In particular, the power supply socket 105 is coupled to the first rod by interposition, between itself and the first rod, of a linear actuator 290 defining a sliding axis K3, perpendicular to the longitudinal axis of the first rod itself and lying on a horizontal plane. In particular, said linear actuator 290 projects in a cantilever fashion from the first rod 155 together with the power supply socket in a direction approaching the second rod 160. In detail, a longitudinal end of said linear actuator is fixed, for example without residual degrees of freedom and preferably also directly, at a longitudinal end of the first rod 155 distal from the first sliding axis K1.

The linear actuator 290 is configured to move the power supply socket 105 along the sliding axis K3 at least at a distance from the first rod such that the distance of the power supply socket 105 from the vertical plane on which the rotation axis of the wheel lies is less than the first predetermined horizontal distance.

Said linear actuator 290 comprises a guide 295, which defines the sliding axis K3 and a resilient element 300, for example comprising a gas spring, configured to generate a thrust along the sliding axis K3 in a direction moving away from the first rod 155. In particular, the guide 295 comprises a first portion fixed, for example without residual degrees of freedom and preferably also directly, to the first rod 155 and a second portion slidingly associated with the first portion and to which the power supply socket 105, for example, without residual degrees of freedom and preferably also directly, is fixed. The resilient element 300 acts on the first portion of the guide of the linear actuator and on the second portion to move the second portion away from the first portion, that is from the first rod. Moreover, the guide 295 of the linear actuator 290 comprises an end-of-stroke device such as to limit the maximal moving away of the power supply socket 105 from the first rod at a position in which the distance of the power supply socket 105 from the vertical plane on which the rotation axis of the wheel lies is less than the first predetermined horizontal distance.

The robot comprises a groove 305 made in the curb and open upwards, communicating with the groove made in the first hump 120 and adapted to contain the power supply socket 105 and the linear actuator 290 at least when the lifting group brings the rods 155, 160 into the first position.

The robot 100 can furthermore comprise a reference element fixed to the power supply socket 105 and adapted to contact the lead-in surface 90. For example, this abutment element projects from the power supply socket 105 in a direction moving away from the first rod 155.

The robot 100 can comprise a protective casing 310, for example box-like shaped, inside which the support frame, the resilient element, the supporting frame and the lifting group are completely contained and which comprises a first slot 315 crossed by the first rod 155 and a second slot 320 crossed by the second rod 160, so that said rods protrude outwardly from the casing.

In particular, the casing 310 has a continuous surface, that is without solutions of continuity, interrupted only by the first slot 315 and the second slot 320. The base and the reference surface are external to the casing 310.

The charging group comprises an electronic control and command unit 325 operatively connected to the robot to actuate it so as to insert the power supply socket 105 into the power charging plug 75.

The electronic control and command unit 325 is operatively connected to the lifting group 145 and is configured to actuate said lifting group so as to bring the rods 155, 160 from the first position to the second position by inserting the power supply socket 105 into the power charging plug 75.

In particular, the electronic control and command unit 325 is also operatively connected to the drive 171 of the first guide 170 and is configured to actuate said drive and the lifting group according to a sequence of steps so as to insert the power supply socket 105 into the power charging plug 75.

The electronic control and command unit 325 can be operatively connected to the presence sensor 135 to be configured to automatically actuate the robot 100 so as to insert the power supply socket 105 into the power charging plug 75, for example to perform such actuation according to the sequence of steps, when it detects by means of said presence sensor 135 the presence of a wheel of the vehicle 1 on the reference surface 110.

It is not excluded that in an alternative embodiment the electronic control and command unit 325 may be configured to perform the actuation of the robot 100 so as to insert the power supply socket 105 into the power charging plug 75, for example to perform such actuation according to the sequence of steps, also or only following a signal which can be manually delivered by a user of the charging group.

Said sequence of steps starts from a stand-by configuration of the vehicle 1 in which the lifting group keeps the rods 155, 160 in the first position. For example, in this stand-by configuration the drive 171 of the first linear guide keeps the rods 155, 160 in an initial end-of-stroke position, in which the power supply socket 105 is at a preset initial distance, in which the distance of the power supply socket 105 from the inner shoulder 40 of the tire when the wheel 10 of the vehicle 1 is on the reference surface is maximal. That is, the distance of the power supply socket is maximal from a vertical reference plane perpendicular to the longitudinal axes of the rods 155, 160 and which passes through an end of the reference surface 110 proximal to the lifting group, that is it passes through an end of the reference surface 110 distal from the power supply socket 105, or in other words it still passes through an end of the distal reference surface 110, along a direction parallel to the longitudinal axes of the rods 155, 160, from the inner shoulder 40 of the tire.

At this preset initial distance, the power charging plug 75 is accommodated entirely in the groove made in the bead 130.

The sequence of steps comprises the step of actuating the lifting group 145 from the first position towards the second position for a preset first lifting distance.

The control of the distance travelled by the rods 155, 160 moving from the first position to the second position is performed by the electronic control and command unit 325 by means of an encoder associated with an electric motor of the lifting group. Therefore by monitoring said encoder the electronic control and command unit 325 interrupts the actuation of the lifting group 145 keeping it in the last reached position when the displacement made by the rods 155, 160 from the first position of the lifting group is equal to the first lifting distance.

This first lifting distance is for example comprised between 3 cm and 38 cm.

Subsequently, the sequence of steps envisages actuating the drive 171 of the first guide 295 in a direction approaching the inner shoulder 40 of the tire 30, that is in a direction approaching the vertical reference plane, so as to bring the first abutment body 280 and the second abutment body 285 in contact with the inner shoulder 40 of the tire. In particular, the robot comprises a first end-of-stroke sensor 350 located at the perpendicular surface of the first abutment body 280 and a second end-of-stroke sensor 355 located at the perpendicular surface of the second abutment body 285 and the electronic control and command unit is configured to interrupt the actuation of the drive 171 during the step described above when it detects by means of the first end-of-stroke sensor and the second end-of-stroke sensor that the perpendicular surface of the first abutment body 280 and the perpendicular surface of the second abutment body have contacted the inner shoulder 40 of the tire.

In the shown embodiment, these end-of-stroke sensors 350,355 comprise a switch. However, it is not excluded that in an alternative embodiment they may comprise any sensor adapted to output a signal when it comes into contact or arrives in the vicinity of another body.

The sequence of steps then comprises the step of actuating the lifting group from the first position to the second position until the electronic control and command unit 325 detects that the power supply socket 105 is inserted in the power charging plug 75. For example, the electronic control and command unit 325 is configured to monitor the passage of an electric current through the power supply socket 105, and/or the cable connected thereto, and to interrupt the actuation of the lifting group 145 when it detects said passage of current.

The electronic control and command unit 325 can also be configured to interrupt the actuation of the lifting group 145 from the first position to the second position and to actuate the lifting group from the reached position towards the first position when it has not yet detected a passage of electric current from the power supply socket to the power charging plug and/or by means of the encoder of the lifting group it detects that the distance travelled by the rods is greater than the vertical distance present between the power charging plug 75 and the rods when they are in the first position, or by means of a third end-of-stroke sensor 360 associated with a top portion of the linear actuator 290.

When the electronic control unit detects said passage of current, the sequence of steps for inserting the power supply socket 105 into the power charging plug 75 has ended. The electronic control and command unit 325 is then configured to monitor the intensity of the current, for example the amperage of the current, which flows in the power supply socket 105, and/or in the cable connected thereto, and to move the lifting group 145 towards the first position when it detects that the intensity of the current has fallen below a predetermined threshold level.

The electronic control and command unit 325 can be configured to interrupt the actuation towards the first position when by means of the encoder of the lifting group it detects that the distance travelled by the rods is equal to the vertical distance present between the power charging plug 75 and the rods when they are in the first position, or by means of a fourth end-of-stroke sensor 365 associated with a lower portion of the linear actuator 290. Furthermore, the electronic control and command unit is configured to actuate the drive 171 of the first linear guide 170 in a direction moving away from the inner shoulder 40 of the tire until it reaches the initial end-of-stroke position of the stand-by configuration of the vehicle 1.

In the shown embodiment, the robot is configured to operate on the rear wheel of the vehicle 1, however it can be configured to operate indistinctly either on the front wheel or on the rear wheel, and according to the position in which the power charging plug 75 is placed.

It is evident from reading the text that the power charging plug positioned in the position described above could also be recharged with a different type of robot without thereby affecting the fact that this position is particularly advantageous for the reasons explained above, in particular thanks to this solution the charging plug is located at a point outside the vehicle 1 in which it is easily accessible, but at the same time it is protected from impacts, which allows extending the useful life of the charging plug itself.

Therefore a charging group comprising a power charging plug adapted to be connected by means of an electric cable to the battery of an electric vehicle 1 and adapted to be rigidly connected to a first portion of a hub of the vehicle 1, which hub comprises the first portion and the second portion which is rotatably associated with the first portion and to which a wheel of the vehicle 1 is integral in rotation, can be worthy of protection independent of a robot as described and as claimed in the present text.

A vehicle 1 may also be worthy of protection independent of the robot as described and as claimed in the present text, which vehicle is provided with a plurality of wheels resting on the ground and an electric battery configured to supply an electric motor of the vehicle 1 adapted to put at least one of said wheels in rotation, said vehicle 1 also comprising a charging group provided with a power charging plug connected by means of an electric cable to the battery of the vehicle 1 and rigidly connected to a first portion of a hub of the vehicle 1, which hub is provided with the first portion and a second portion directly integral in rotation with a wheel of the vehicle 1 and rotatably associated with the first portion. The charging group can then comprise a lead-in surface and the plug can be positioned with respect to the hub according to any one of the above described and/or claimed characteristics.

Furthermore, it is also clear that the robot according to at least one of the features described above could be used to connect the power supply socket to a power charging plug positioned in another point of the vehicle 1, since this possibility would depend only on the shape of the rod to which the power supply socket is connected and how the linear actuator 290 connected thereto is oriented. For example the power charging plug could be fixed to an underbody portion of the vehicle 1 and the robot could be used to operate on a rear wheel of the vehicle 1 and be provided with a first suitably shaped rod, still allowing the battery of the vehicle 1 to be charged.

Therefore the reasons for which the robot is worthy of separate protection, independent of the position of the electrical charging plug, are evident. Moreover, it is also evident that the combination of the robot according to at least one of the features described above and/or claimed and the power charging plug associated with the wheel hub, when joined together allow amplifying the advantage that the present invention promises to achieve, that is a greater robustness, simplicity, therefore fewer delicate details that can break, constant use efficiency, and the fact of being suitable for being installed in outdoor public places, compared to known automatic charging systems.

The operation of the invention described above is as follows.

When the wheel of the vehicle 1 is positioned on the reference surface at which the power charging plug 75 is installed, the electronic control and command unit 325 actuates the lifting group 145 and the drive 171 according to the sequence of steps described above. During the lifting of the rods 155, 160, the resilient element 265 forces the same rods, for example the rollers, to slide along the tread of the tire, which is substantially clamped between the rods.

If the wheel 10 is not perfectly oriented with respect to the robot, that is the rotation axis of the wheel, it does not lie on a vertical plane equidistant from the longitudinal axes of the first rod 155 and of the second rod 160, the resilient element, for example assisted by the mechanism configured to simultaneously move away and approach the rods 155, 160 along the respective sliding axes, pushes the rods into contact with the tread until, thanks to the degrees of freedom guaranteed by the bearing and the second linear guide 185, the rods, that is, the rollers contact the tread along a whole linear section thereof between the inner shoulder and the inner shoulder.

After the electronic control and command unit 325 has commanded the drive 171 to bring at least the first reference element, that is the perpendicular surface thereof, in contact with the inner shoulder of the tire, during the subsequent ascent of the first rod, the power supply socket 105, or the abutment body connected thereto, is kept in contact with the lead-in surface 90 under the thrust of the resilient element of the linear actuator, which lead-in surface during the ascent of the first rod towards the second position vertically aligns the power supply socket 105 to the power charging plug 75, thus enabling the engagement thereof.

Once the battery 5 of the vehicle 1 has been charged, the electronic control and command unit 325 actuates the lifting group 145 and the drive to bring the rods back to the stand- by configuration of the vehicle 1 in which the power supply socket 105 and the rods are placed respectively inside the curb and the humps, so that the rods do not interfere with the vehicle 1 which can therefore be displaced from the reference surface.

The invention thus conceived is susceptible to several modifications and variations, all falling within the scope of the inventive concept.

Moreover, all the details can be replaced by other technically equivalent elements.

In practice, the materials used, as well as the contingent shapes and sizes, can be whatever according to the requirements without for this reason departing from the scope of protection of the following claims.

1. A robot for the automatic electric charging an of electric vehicle comprising:
a reference surface,
a first rod and a second rod, which are coplanar and parallel to each other,
a support frame with which the first rod and the second rod are slidingly associated respectively along a first sliding axis (K1), perpendicular to a longitudinal axis (L1) of the first rod, and a second sliding axis (K2), perpendicular to a longitudinal axis (L2) of the second rod, and wherein said rods are movable along said sliding axes between a first position, in which the mutual distance between the rods is minimal, and a second position, in which the mutual distance between the rods is maximal,
a resilient element configured to exert a force on said rods such that in order to bring the rods from the first position to the second position it is necessary to overcome said force of the resilient element,
a supporting frame with which the support frame is slidingly associated with respect to a sliding axis (X) parallel to the longitudinal axes (L1, L2) of the rods,
a lifting group configured to move the supporting frame along a vertical direction, between a first position, in which the distance of the rods from the reference surface is minimal, and a second position, in which the rods are located at a higher level than the reference surface and the distance from the reference surface is maximal, and
a power supply socket adapted to be connected by a cable to an electric power source, said power supply socket (being coupled to the first rod.

2. The robot according to claim 1, the support frame is rotatably associated with the supporting frame with respect to a vertical rotation axis (Z).

3. The robot according to claim 1, comprising a first roller rotatably associated with the first rod with respect to the longitudinal axis (L1) of the first rod itself and a second roller rotatably associated with the second rod with respect to the longitudinal axis (L2) of the second rod itself.

4. The robot according to claim 1, wherein the power supply socket is of the type comprised in the group among type 1, type 2, ccs2 and chademo.

5. The robot according to claim 1, comprising a base provided with the reference surface, a first hump and a second hump placed side by side with the reference surface along a direction transverse to the longitudinal axes (L1, L2) of the first rod and of the second rod and projecting vertically from the reference surface, wherein the first hump comprises a groove adapted to accommodate the first rod and the second hump comprises a groove adapted to accommodate the second rod.

6. The robot according to claim 1, comprises a protective casing inside which the support frame, the resilient element and the lifting group are completely contained and which comprises a first slot crossed by the first rod and a second slot crossed by the second rod, in such a way that said rods protrude outwardly from the casing.

7. A charging group comprising:
a power charging plug adapted to be electrically connected by an electric cable to a battery of an electric vehicle provided with wheels resting on the ground,
a robot according to claim 1 which inserts the power supply socket into the power charging plug so as to form an electrical connection,
wherein the power charging plug is adapted to be rigidly connected to a first portion of a hub of the vehicle, which hub comprises the first portion and a second portion rotatably associated with the first portion and to which a wheel of the plurality of wheels is connected.

8. The charging group according to claim 7, wherein the power supply socket of the robot is connected to the first rod by a resilient element configured to push the power supply socket along a direction transverse to the longitudinal axis (L1) of the first rod itself, and wherein the charging group comprises a lead-in surface, which is convergent towards the power charging plug, is adapted to be rigidly connected to the first portion of the hub, and is configured to be contacted by the power supply socket under the thrust of said resilient element to guide at least in part the power supply socket towards the power charging plug.

9. An automotive apparatus comprising an electric vehicle, which is provided with a plurality of wheels resting on the ground and an electric battery configured to supply an electric motor of the vehicle adapted to put at least one of said wheels in rotation, said automotive apparatus also comprising a charging group provided with:
a power charging plug connected by an electric cable to the battery of the vehicle and rigidly connected to a first portion of a hub of the vehicle, the hub being provided with the first portion and a second portion directly integral in rotation with a wheel of the vehicle and rotatably associated with the first portion,
a robot according to claim which inserts the power supply socket into the power charging plug so as to form an electrical connection.

10. The automotive apparatus according to claim 9, wherein the power supply socket of the robot is connected to the first rod by a resilient element configured to push the power supply socket along a direction transverse to the longitudinal axis (L1) of the first rod itself and wherein at least one of the vehicle and the charging group comprises a lead-in surface which is rigidly connected to the first portion of the hub and is convergent towards the power charging plug.
